(19) United States
(12) Patent Application Publication
(10) Pub. No.: US 2004/0237377 A1
(43) Pub. Date: Dec. 2, 2004

(54) Trolling board storage device

(75) Inventor: Jerome E. Tipping, Milton, WI (US)

Correspondence Address: WHYTE HIRSCHBOECK DUDEK S C, 555 EAST WELLS STREET, SUITE 1900, MILWAUKEE, WI, 53202, US

(73) Assignee: Angler's Pride Specialties, Milton, WI

(21) Appl. No.: 10/438,554

(22) Filed: May 15, 2003

(51) Int. Cl. A01K 97/00

(52) U.S. Cl. 43/54.1

(57) ABSTRACT

Disclosed herein is a trolling board storage device for use with at least one trolling board. The device comprises a wire frame bent to create a trolling board storage area for storing at least one trolling board. In one embodiment, the wire frame comprises: a generally U-shaped portion comprising a plurality of substantially parallel U-shaped wires, the plurality of substantially parallel U-shaped wires connected by a pair of wires that are positioned substantially perpendicular to the plurality of substantially parallel U-shaped wires; and a generally L-shaped portion connected to the U-shaped portion, the substantially L-shaped portion comprising a plurality of substantially parallel L-shaped wires, the plurality of substantially parallel L-shaped wires connected by a wire that is positioned substantially perpendicular to the plurality of substantially parallel L-shaped wires. In one embodiment, the generally L-shaped portion and the generally U-shaped portion are in overlay relationship with one another. In one embodiment, the wire frame defines at least one trolling board extension clearance channel, the channel for receiving an extension attached to the at least one trolling board. Also disclosed herein is a trolling board storage device in combination with at least one trolling board, as well as a trolling board storage kit. The device holds and secures one or more trolling boards, and in doing so promotes proper drying of the typically wet or damp boards, so that the boards may be properly maintained for long term use.

### FIELD AND BACKGROUND OF THE INVENTION

The invention relates generally to boating equipment and more particularly to a trolling board storage device.

In the maritime arena, trolling boards, also known as trollers, planer boards and outrigger floats, are commonly used to float near a boat or fishing vessel and receive and maintain the integrity of numerous fishing lines extending from the fishing vessel. The boat tows the trolling boards with tow lines in a conventional manner. Typically, the towing line is attached to the trolling board by a trolling arm, as well as to the fishing lines. The fishing lines can be subsequently disengaged from the towing line as desired, for example, when reacting to a strike on one of the fishing lines.

Trolling boards, as maritime equipment, are often stored directly on the boat from which the fishing lines will be cast so as to be readily available to a user. In most cases, storage of the trolling boards occurs in a variable or ad hoc basis, by which any particular container, hold or holding area on the boat is utilized to store the trolling board. Since trolling boards are not generally considered when designing boats, there is not a holding or securing apparatus specifically made for trolling boards and that can be used on a boat. Consequently, damage to holding areas not designed for trolling boards, as well as damage to tow arms or other trolling board parts occurs from improper storage of the trolling boards. Moreover, the trolling boards tend to lay or be stored so as to clutter useable and limited space on a boat.

In addition, trolling boards are typically stored shortly after use, and as such they are stored typically when wet, or at least damp.

Accordingly, a need exists in the marketplace for a device that can specifically hold and secure one or more trolling boards, a device that can promote proper drying of the typically wet or damp boards, so that the boards may be properly maintained for long term use.

### BRIEF SUMMARY OF THE INVENTION

Disclosed herein is a trolling board storage device for use with at least one trolling board, the device comprising a wire frame bent to create a trolling board storage area for storing at least one trolling board.

In one embodiment, the wire frame comprises: a generally U-shaped portion comprising a plurality of substantially parallel U-shaped wires, the plurality of substantially parallel U-shaped wires connected by a pair of wires that are positioned substantially perpendicular to the plurality of substantially parallel U-shaped wires; and a generally L-shaped portion connected to the U-shaped portion, the substantially L-shaped portion comprising a plurality of substantially parallel L-shaped wires, the plurality of substantially parallel L-shaped wires connected by a wire that is positioned substantially perpendicular to the plurality of substantially parallel L-shaped wires.

In another embodiment, the wire frame further defines at least one trolling board extension clearance channel, the channel for receiving an extension attached to the at least one trolling board.

According to another aspect, disclosed herein is trolling board storage device in combination with at least one trolling board, the combination comprising: a wire frame bent to create a trolling board storage area; and at least one trolling board for secured placement at least partially within the trolling board storage area.

According to still another aspect of the present invention, trolling board storage kit comprising: a trolling board storage device comprising a wire frame bent to create a trolling board storage area for securing at least one trolling board; and mounting hardware packaged with the device, the hardware for mounting the device one of directly and indirectly to a boat.

Other embodiments, objects, aspects, and advantages of the present invention will become apparent upon a reading of the detailed description that follows, including the claims, in view of the drawings.

### BRIEF DESCRIPTION OF THE DRAWINGS

The drawings illustrate the best mode presently contemplated for carrying out the invention.

In the drawings:

FIG. 1 is a perspective of one embodiment of a trolling board storage device according to one aspect of the present invention;

FIG. 2 is a reverse perspective view of the trolling board storage device of FIG. 1;

FIG. 3 is a front view of the trolling board storage device of FIG. 1;

FIG. 4 is a left side elevational view of the trolling board storage device of FIG. 1;

FIG. 5 is a top plan view of the trolling board storage device of FIG. 1;

FIG. 6 is a bottom plan view of the trolling board storage device of FIG. 1;

FIG. 7 is a enlarged sectional taken along line 7-7 of FIG. 5;

FIG. 8 is a perspective view of another embodiment of a trolling board storage device according to one aspect of the present invention;

FIG. 9 is a front view of the trolling board storage device of FIG. 8;

FIG. 10 is a perspective view of a trolling board storage device in combination with a trolling board according to one aspect of the present invention;

FIG. 11 is a perspective view of another embodiment of the trolling board storage device in combination with a trolling board according to one aspect of the present invention; and

FIG. 12 is a trolling board storage kit according to one aspect of the present invention.

### DETAILED DESCRIPTION OF THE INVENTION

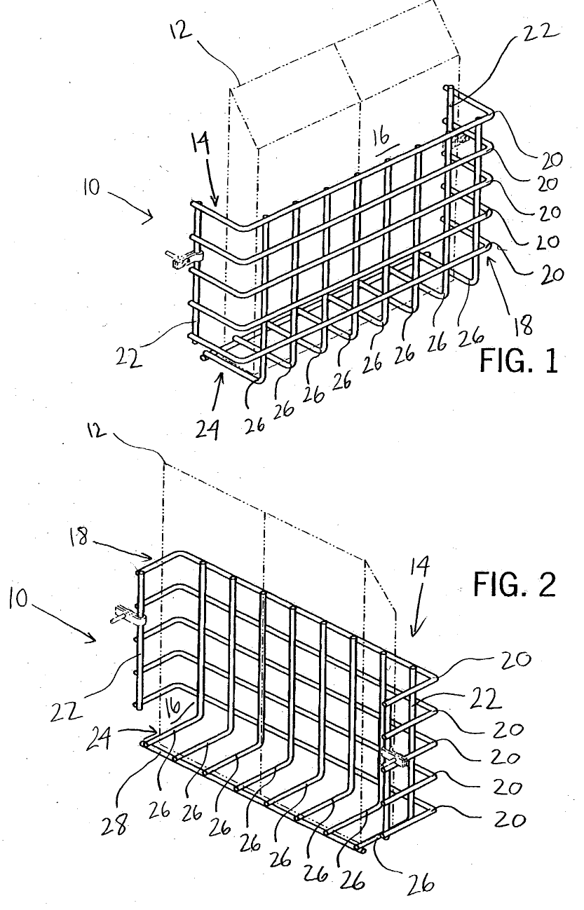

FIGS. 1 and 2 are perspective and reverse perspective views, respectively, of one embodiment of a trolling board storage device 10 according to one aspect of the present invention. Device 10 is designed for use with at least one trolling board 12 (a plurality of which are shown in phantom). The device comprises a wire frame 14 that is bent to create a trolling board storage area 16 for secured placement of a trolling board therein.

The trolling board storage device, in the embodiments illustrated herein, are sized to accommodate two trolling boards. However, it is contemplated that the exact dimensions of the device can be varied to accommodate any desired number of trolling boards.

Wire frame 14 of trolling board storage device 10 includes a generally U-shaped portion 18 comprising a plurality of substantially parallel U-shaped wires 20. The plurality of substantially parallel U-shaped wires 20 connected by a pair of wires 22 that are positioned substantially perpendicular to the plurality of substantially parallel U-shaped wires. A generally L-shaped portion 24 is connected to the U-shaped portion 18. The substantially L-shaped portion 24 comprises a plurality of substantially parallel L-shaped wires 26 and the plurality of substantially parallel L-shaped wires are connected by a wire 28 that is positioned substantially perpendicular to the plurality of substantially parallel L-shaped wires. As shown, the connection between the generally U-shaped portion and the generally L-shaped portion results in an overlay relationship between the generally L-shaped portion and the generally U-shaped portion.

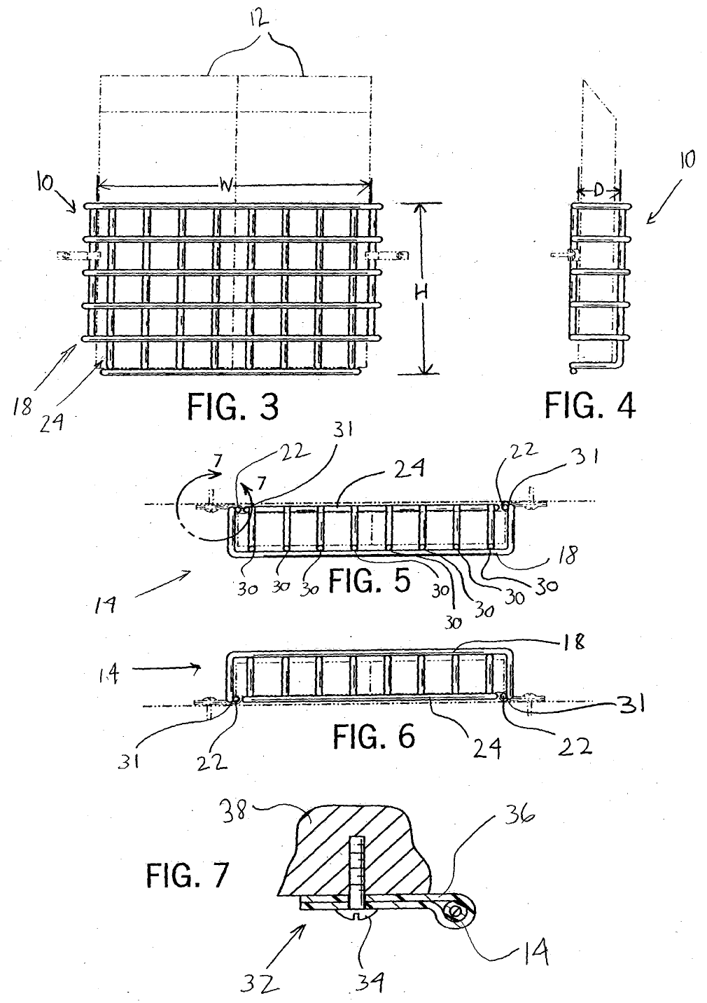

FIGS. 3 and 4 are front and left side elevational views of the trolling board storage device of FIG. 1. Here, it can be seen that generally U-shaped portion 18 overlays the generally L-shaped portion 24 to create a mesh, or grid-like latticework. In the embodiment shown, the overall width W of the latticework is about 9 inches, the overall depth D is about 1.25 inches, and the height H is about 5 inches. These dimensions result in a size of device 10 that can readily accommodate 2 trolling boards 12 for storage. Exemplary trolling boards that can be stored in the trolling board storage device in this embodiment are the Off Shore, Willie, and Yellow Bird types of trolling boards. Off Shore boards are available from Off Shore Tackle, located in Port Austin, Mich., and Yellow Bird boards are available from Ed Shirley Sports, located in Chicago, Ill.

The latticework provides a support and storage structure for trolling boards before and following use. Advantageously, the latticework provides a means for air to pass over the boards which are typically wet following use. In general, the latticework can be made of steel or other suitable material (i.e., a material that can provide the requisite strength, malleability, endurance). In one embodiment, the wire frame can be coated with, for example, a polyarmor coating or other coating to provide benefits such as corrosion prevention, increased product life of the storage device, among others.

FIGS. 5 and 6 are top and bottom plan views, respectively, of the trolling board storage device of FIG. 1. As can be clearly seen in this view, the generally U-shaped portion 18 and the generally L-shaped portion 24 are connected via a plurality of connection points 30 to create the wire frame 14. In addition, parallel end wires 22 are connected by connection points 31 (although not shown, end wire for connecting at connection points the L-shaped wires). In one preferred embodiment, connection points are welded connection, and as such, the wire frame can be termed a “welded wire frame”. In a preferred embodiment, the welded wire frame, and more particularly, the wire of the welded wire frame, is steel.

FIG. 7 is an enlarged sectional view taken along line 7-7 of FIG. 5. Mounting hardware 32, which can include a screw 34 and a clip 36, typically made of steel, is shown connected to wire frame 14, for mounting the frame, and in generally the storage device, to a structure 38 (e.g., a boat, a storage locker, a rod locker, or other container, etc.) for secure placement. Connection between the mounting hardware and wire frame can be varied in its location to convenience.

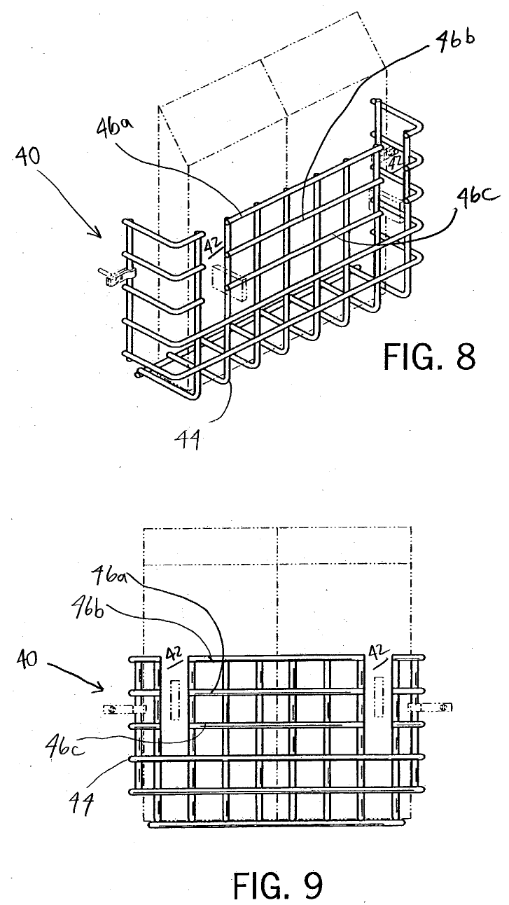

FIG. 8 is a perspective view of another embodiment of a trolling board storage device according to one aspect of the present invention, and FIG. 9 is a front view of the trolling board storage device of FIG. 8. Many trolling boards include shelf brackets or other hardware to which the planer release is attached. Because of the additional hardware attached to the trolling board, any storage device for the trolling boards should accommodate the additional hardware so that the trolling board is not damaged by improperly forcing the trolling board into an inadequate space. To that end, trolling board storage device 40 includes, in the embodiment illustrated, a pair trolling board extension clearance channels 42. The channels are formed within the storage device 40, and specifically, in the frame 44 of the device. In one embodiment, the channels 42 can be created by removing portions of wires 46a-c, or put another way, each trolling board extension clearance channel can extend across three of the substantially parallel U-shaped wires 46a-c. In general, it is contemplated that the channels can be sized and shaped to convenience, and accommodate the trolling board(s) that is intended to be stored therein. Exemplary trolling boards that can be stored in the trolling board storage device shown in this embodiment are the Mr. Walleye and the Rover types of trolling boards. Mr. Walleye boards are available from Church Tackle, located in Sodus, Mich.

In one embodiment, the portions of wires are removing by a clipping or cutting operation. Accordingly, in one embodiment, three wire portions can be removed to create each channel. In another embodiment, the clearance channels can be formed by creating discrete body or wire frame portions, and connecting those portions together.

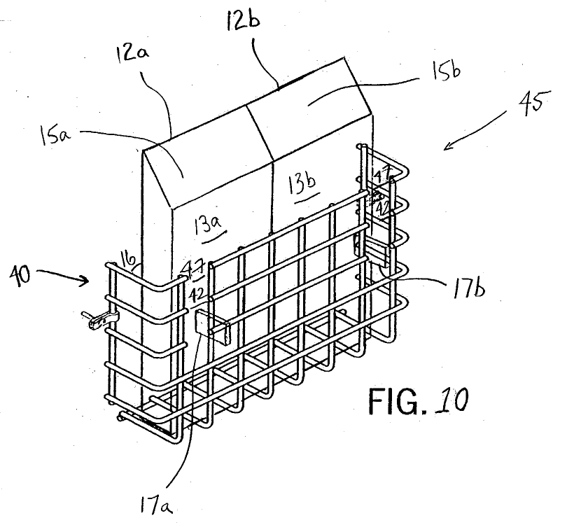

FIG. 10 is a perspective view of trolling board storage device 40 shown in combination with a trolling boards 12a-b, according to one aspect of the present invention. Together, the device and boards create a combination 45. As shown, the trolling boards are positioned within, and substantially fill, the trolling board storage area previously described with reference to FIGS. 1 and 2. Trolling boards typically include a straight portion 13a-b and an angled portion 15a-b. As illustrated, the storage device 40 provides for secure placement of the trolling boards by securing at least a portion of the straight trolling board portions 13a-b, while permitting the angled portions 15a-b to extend out from the trolling board storage, thereby facilitating easy removable by a user. Trolling boards 12a-b include extensions 17a-b which are brackets to which planer releases can be attached. As shown, the extensions are connected to straight trolling board portions 13a-b and reside in trolling board extension clearance channels 42 after passing the channel thresholds 47, which are disposed at the upper end of the channels. Each trolling board extension clearance channel typically extends in a substantially vertical direction when the device is mounted.

FIG. 11 is a perspective view of another embodiment of a trolling board storage device 10 in combination with, as shown, a pair of trolling boards 12a-b according to one aspect of the present invention. Together the device and boards make up combination 50. Here again, trolling boards 12a-b are positioned within storage area 46 of the storage device 10. In this and in other contemplated embodiments, one advantage of the present invention is that the water on the boards following use can easily drain away, such that drying can occur more rapidly.

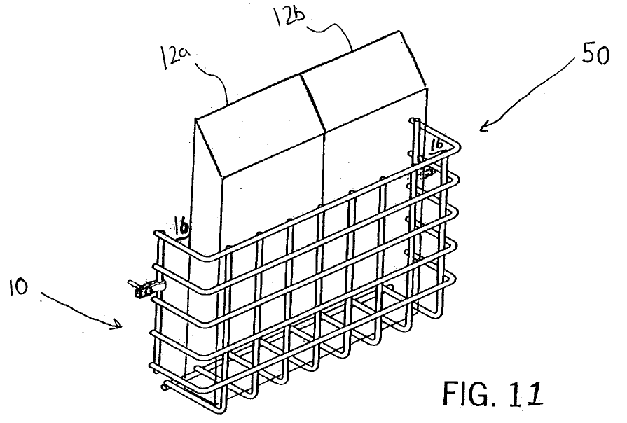

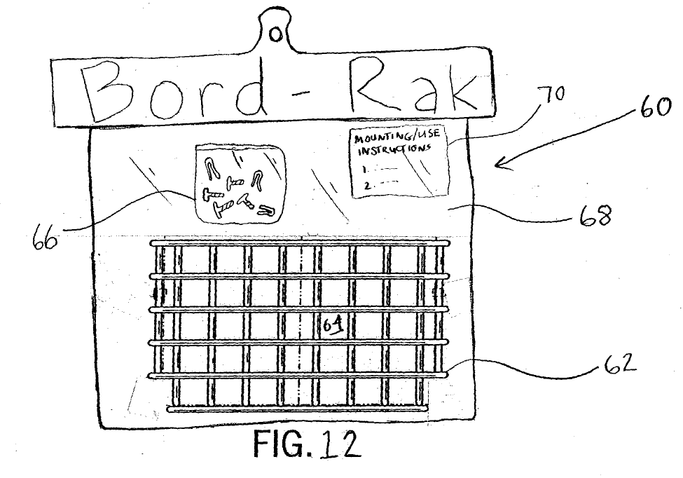

FIG. 12 is a trolling board storage kit 60 according to one aspect of the present invention. The trolling board storage kit 60 includes a trolling board storage device 62 having a wire frame bent to create a trolling board storage area 64 that can be used for securing at least one trolling board (boards 12a-b of FIGS. 10-11). Also shown and included in the kit 60 is mounting hardware 66 which can be packaged using packaging 68 (e.g., a plastic wrapping material) with the device 62. The hardware can be used to mount the device either directly or indirectly to a boat. Again, the device can be indirectly mounted or secured to a boat by mounting the trolling board storage device, for example, to a storage locker securably positioned in the boat. A standard kit can also include such ancillary items as instructions for use and/or mounting 70.

The present invention has been described in terms of preferred embodiments. Equivalents, alternatives, and modifications, aside from those expressly stated herein, are possible and should be understood to be within the scope of the appending claims.

What is claimed is:

1. A trolling board storage device for use with at least one trolling board, the device comprising:
a wire frame bent to create a trolling board storage area for storing at least one trolling board.

2. The device of claim 1 wherein the wire frame comprises:
a generally U-shaped portion comprising a plurality of substantially parallel U-shaped wires, the plurality of substantially parallel U-shaped wires connected by a pair of wires that are positioned substantially perpendicular to the plurality of substantially parallel U-shaped wires; and
a generally L-shaped portion connected to the U-shaped portion, the substantially L-shaped portion comprising a plurality of substantially parallel L-shaped wires, the plurality of substantially parallel L-shaped wires connected by a wire that is positioned substantially perpendicular to the plurality of substantially parallel L-shaped wires.

3. The device of claim 2 wherein the generally L-shaped portion and the generally U-shaped portion are in overlay relationship with each other.

4. The device of claim 2 wherein the wire frame is a welded wire frame and wire of the welded wire frame is steel.

5. The device of claim 1 wherein the wire frame is coated with a polyarmor coating.

6. The device of claim 3 wherein the wire frame further defines at least one trolling board extension clearance channel, the channel for receiving an extension attached to the at least one trolling board.

7. The device of claim 6 wherein the wire frame defines at least two trolling board extension clearance channels.

8. The device of claim 6 wherein the at least one trolling board extension clearance channel extends across three of the substantially parallel U-shaped wires.

9. The device of claim 6 wherein each trolling board extension clearance channel extends in a substantially vertical direction when the device is mounted.

10. A trolling board storage device in combination with at least one trolling board, the combination comprising:
a wire frame bent to create a trolling board storage area; and
at least one trolling board for secured placement at least partially within the trolling board storage area.

11. The combination of claim 10 wherein the wire frame comprises:
a generally U-shaped portion comprising a plurality of substantially parallel U-shaped wires, the plurality of substantially parallel U-shaped wires connected by a pair of wires that are positioned substantially perpendicular to the plurality of substantially parallel U-shaped wires; and
a generally L-shaped portion connected to the U-shaped portion, the substantially L-shaped portion comprising a plurality of substantially parallel L-shaped wires, the plurality of substantially parallel L-shaped wires connected by a wire that is positioned substantially perpendicular to the plurality of substantially parallel L-shaped wires.

12. The combination of claim 11 wherein the generally L-shaped portion and the generally U-shaped portion are in overlay relationship with one another.

13. A trolling board storage kit comprising:
a trolling board storage device comprising a wire frame bent to create a trolling board storage area for securing at least one trolling board; and
mounting hardware packaged with the device, the hardware for mounting the device one of directly and indirectly to a boat.

16. The kit of claim 15 wherein the mounting hardware includes a steel screw and a clip.

17. The kit of claim 15 further including a set of instructions for one of kit use and mounting of the kit using the mounting hardware.
